(19) United States
(12) Patent Application Publication
(10) Pub. No.: US 2023/0151195 A1
(43) Pub. Date: May 18, 2023

(54) ENHANCED MELT STRENGTH LOW-DENSITY POLYETHYLENE FOR USE IN FILMS OR BLENDS

(71) Applicant: Dow Global Technologies LLC, Midland, MI (US)

(72) Inventors: Teresa P. Karjala, Lake Jackson, TX (US); John A. Naumovitz, Midland, MI (US); Yongchao Zeng, Houston, TX (US); Shadid Askar, Houston, TX (US); Joshua R. Ingeholm, Houston, TX (US); Jonathan D. Mendenhall, Lake Jackson, TX (US); Jose Ortega, Lake Jackson, TX (US); John P. O'Brien, Manvel, TX (US)

(73) Assignee: Dow Global Technologies LLC, Midland, MI (US)

(21) Appl. No.: 17/995,538

(22) PCT Filed: Mar. 29, 2021
(86) PCT No.: PCT/US2021/024600

§ 371 Date: Oct. 5, 2022

Related U.S. Application Data
(60) Provisional application No. 63/005,798, filed on Apr. 6, 2020.

(51) Int. Cl. C08L 23/06; C08J 5/18

(52) U.S. Cl. CPC C08L 23/06; C08J 5/18; C08J 2323/06; C08L 2203/16; C08L 2207/066

(57) ABSTRACT

A low-density polyethylene having a melt strength measured at 190 C that is greater than or equal to 5.5 cN, a density that is greater than or equal to 0.9210 g/cm³ and less than or equal to 0.9275 g/cm³, and, and a melt index I₂ measured at 190° C. that is greater than or equal to 4.5 g/10 min.

### CROSS REFERENCE TO RELATED APPLICATIONS

This application claims priority to U.S. Provisional Pat. Application No. 63/005,798, filed on Apr. 6, 2020, the entire disclosure of which is hereby incorporated by reference.

### TECHNICAL FIELD

Embodiments of the present disclosure generally relate to low-density polyethylenes, and particularly to low-density polyethylenes with an enhanced melt strength.

### BACKGROUND

Properties of resins used to produce films, such as melt strength, viscosity, molecular weight distribution, density, and the like can affect the performance of the films, such as cast, blown, or thermoformed films. Blending different types of ethylene-based polymers, such as low-density polyethylene (LDPE) with Linear Low-density Polyethylene (LLDPE), can improve some of the properties, but this blending can lead to inconsistencies between batches.

Ethylene-based polymers are disclosed in the following references: WO 2017/14698 WO 2010/042390, WO 2010/144784, WO 2011/019563, WO 2012/082393, WO 2006/049783, WO 2009/114661, US 2008/0125553, US 7,741,415, US 8,916,667, US 9,303,107, and EP 2239283B1. However, such polymers do not provide an improved melt strength and an optimized balance of film properties. Thus, there remains a need for new ethylene-based polymers, such as LDPEs, that have an optimized balance of melt strength, processability, and density (stiffness).

### SUMMARY

In embodiments, a low-density polyethylene comprises: a melt strength measured at 190° C. (°C) that is greater than or equal to 5.5 centiNewtons (cN); a density that is greater than or equal to 0.9210 grams per cubic centimeter (g/cm³) and less than or equal to 0.9275 g/cm³; and a melt index, I₂, measured at 190° C. that is greater than or equal to 4.5 g/10 min.

In embodiments, a low-density polyethylene comprises: a melt strength measured at 190° C. that is greater than 5.5 cN; and a density that is greater than or equal to 0.9210 g/cm³ and less than or equal to 0.9275 g/cm³.

Additional features and advantages will be set forth in the detailed description that follows, and in part will be readily apparent to those skilled in the art from that description or recognized by practicing the embodiments described herein, including the detailed description, which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a process system according to embodiments disclosed and described herein;

FIG. 2 graphically depicts a CDF_{IR} chromatogram for a low-density polyethylene according to embodiments disclosed and described herein;

FIG. 3 graphically depicts a CDF_{DV} chromatogram for a low-density polyethylene according to embodiments disclosed and described herein.

FIG. 4 graphically depicts a CDF_{LS} chromatogram for a low-density polyethylene according to embodiments disclosed and described herein;

FIG. 5 graphically depicts a LSP chromatogram for a low-density polyethylene according to embodiments disclosed and described herein; and

FIG. 6 graphically depicts a melt strength overlay at 190° C. for a low-density polyethylene according to embodiments disclosed and described herein.

### DETAILED DESCRIPTION

Specific embodiments of the present application will now be described. The disclosure may, however, be embodied in different forms and should not be construed as limited to the embodiments set forth in this disclosure. Rather, these embodiments are provided so that this disclosure will be thorough and complete, and will fully convey the scope of the subject matter to those skilled in the art.

According to embodiments, a low-density polyethylene comprises: a melt strength measured at 190° C. that is greater than or equal to 5.5 cN; a density that is greater than or equal to 0.9210 g/cm³ and less than or equal to 0.9275 g/cm³; and a melt index I₂ measured at 190° C. that is greater than or equal to 4.5 g/10 min. According to embodiments, a low-density polyethylene comprises: a melt strength measured at 190° C. that is greater than 5.5 cN and a density that is greater than or equal to 0.9210 g/cm³ and less than or equal to 0.9275 g/cm³.

### Definitions

The term “composition,” as used herein, includes a mixture of materials that comprise the composition, as well as reaction products and decomposition products formed from the materials of the composition.

The terms “blend” or “polymer blend,” as used, refers to a mixture of two or more polymers. A blend may or may not be miscible (phase separated at the molecular level). A blend may or may not be phase separated. A blend may or may not contain one or more domain configurations, as determined from transmission electron spectroscopy, light scattering, x-ray scattering, and other methods known in the art. The blend may be effected by physically mixing the two or more polymers on the macro level (for example, melt blending resins or compounding) or the micro level (for example, simultaneous forming within the same reactor).

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

The term “low-density polyethylene” abbreviated as “LDPE,” as used herein, may also be referred to as “high pressure ethylene polymer” or “highly branched polyethylene.” LDPE is known in the art, and herein refers to an ethylene homopolymer prepared using a free-radical, high pressure (≥ 100 MPa (for example, 100-400 MPa)) polymerization. LDPE resins typically have a density in the range of 0.915 to 0.935 g/cm³. As referred to herein, the terms low-density polyethylene, LDPE, or the like refers to the polyethylene polymer itself and does not include any additives that may be blended with the low-density polyethylene unless explicitly stated otherwise. Accordingly, the properties of the low-density polyethylene referred to in this disclosure refer to the properties of the low-density polyethylene polymer itself, without any additives, unless explicitly stated otherwise.

The term “linear low-density polyethylene” abbreviated as “LLDPE,” as used herein, includes resin made using Ziegler-Natta catalyst systems as well as resin made using single-site catalysts, including, but not limited to, bis-metallocene catalysts (sometimes referred to as “m-LLDPE”), phosphinimine, and constrained geometry catalysts; and resin made using post-metallocene, molecular catalysts, including, but not limited to, bis(biphenylphenoxy) catalysts (also referred to as polyvalent aryloxyether catalysts). LLDPE includes linear, substantially linear, or heterogeneous ethylene-based copolymers or homopolymers. LLDPEs include the substantially linear ethylene polymers, which are further defined in U.S. Patent No. 5,272,236; U.S. Pat. No. 5,278,272; U.S. Pat. No. 5,582,923; and U.S. Pat. No. 5,733,155; the homogeneously branched ethylene polymers such as those in U.S. Pat. No. 3,645,992; the heterogeneously branched ethylene polymers such as those prepared according to the process disclosed in U.S. Pat. No. 4,076,698; and blends thereof (such as those disclosed in U.S. Pat. No. 3,914,342 or U.S. Pat. No. 5,854,045). The LLDPE resins can be made via gas-phase, solution-phase or slurry polymerization or any combination thereof, using any type of reactor or reactor configuration known in the art.

### Processes of Embodiments

For producing the low-density polyethylene, a high pressure, free-radical initiated, autoclave tubular reactor combination polymerization process was used. Two different high pressure free-radical initiated polymerization process types are known. In the first type, an agitated autoclave vessel having one or more reaction zones is used. The autoclave reactor normally has several injection points for initiator or monomer feeds, or both. In the second type, a jacketed tube is used as a tubular reactor, which has one or more reaction zones. Suitable, but not limiting, reactor lengths may be from 100 to 3000 meters (m), or from 1000 to 2000 m. The beginning of a reaction zone for the reactor is typically defined by the side injection of either initiator of the reaction, ethylene, chain transfer agent (or telomer), comonomer(s), as well as any combination thereof. A high pressure process can also be carried out in autoclave or tubular reactors having one or more reaction zones, or in a combination of autoclave and tubular reactors, each comprising one or more reaction zones.

A chain transfer agent can be used to control molecular weight. In a preferred embodiment, one or more chain transfer agents (CTAs) may be added to a polymerization process. Typical CTA’s include, but are not limited to, propylene, isobutane, n-butane, 1-butene, methyl ethyl ketone, acetone, and propionaldehyde. In one embodiment, the amount of CTA used in the process is from 0.03 to 10 weight percent of the total reaction mixture.

Ethylene used for the production of the low-density polyethylene may be purified ethylene, which is obtained by removing polar components from a loop recycle stream. It is not typical that purified ethylene is required to make the low-density polyethylene. In such cases ethylene from the recycle loop may be used.

Reference will now be made in detail to embodiments of systems and processes for producing low-density polyethylenes according to embodiments disclosed and described herein.

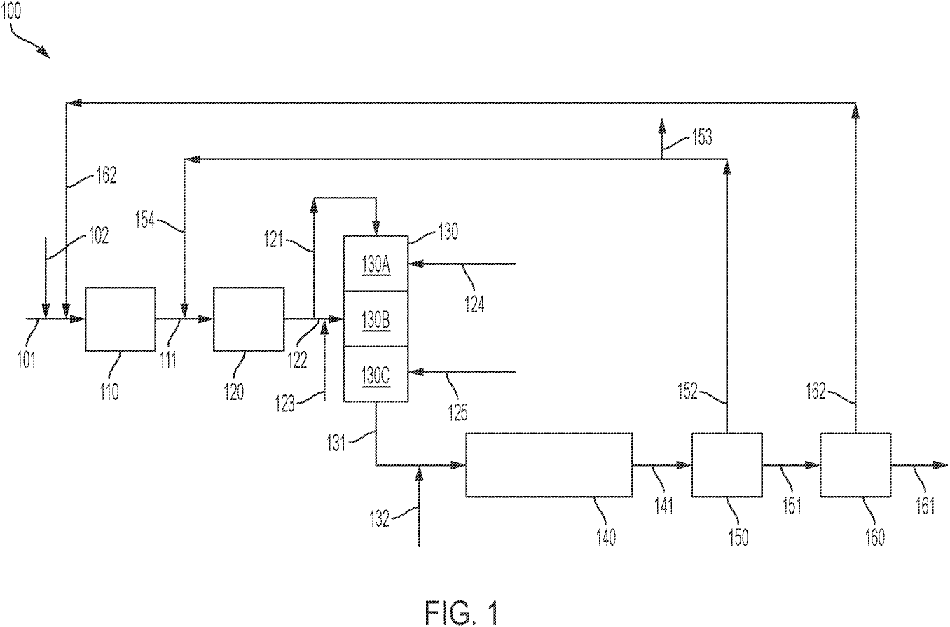

With reference now to FIG. 1, which is a block diagram of a process reaction system used to produce a low-density polyethylene according to embodiments, the process reaction system 100 shown in FIG. 1 is a partially closed-loop, dual recycle, high-pressure, low-density polyethylene system. According to embodiments shown in FIG. 1, the process reaction system 100 may comprise a booster/primary compressor 110, a hypercompressor 120, an adiabatic autoclave reactor 130 coupled with tube reactor 140, a high pressure separator 150, and a low pressure separator 160. The autoclave reactor 130 may, according to embodiments comprise three zones 130A, 130B, 130C. A first peroxide initiator stream 124 may be injected into each zone one 130A of the autoclave reactor 130 and a third peroxide initiator stream 125 may be injected into zone three 130C of the autoclave reactor 130. A second peroxide initiator stream 123 may be either mixed with a side stream 122 or injected into zone two of the reactor 130B. Similarly, a peroxide initiator stream 132 may be injected to the inlet of the tube reactor 140. The tube reactor 140 may use cooling jackets (not shown) mounted around the outer shell of the tube reactor 140. The cooling jackets of the tube reactor 140 may use high pressure water to cool or regulate the temperature in the tube reactor 140.

A fresh ethylene feed stream 101 may be mixed with a chain transfer agent (CTA) stream 102 and an ethylene rich stream 162 to form a first mixed stream (i.e., a mixed stream of fresh ethylene, high pressure ethylene recycle, and CTA). This first mixed stream may be introduced into the booster/primary compressor 110 that is sequentially connected to the hypercompressor 120, which is downstream of the booster/primary compressor 110. In the booster/primary compressor 110, the mixed stream is compressed and exits the booster/primary compressor 110 as compressed stream 111. Compressed stream 111 may be mixed with a high pressure recycle stream 154—that is a portion of an ethylene rich stream 152 of the high pressure separator 150—to form a second mixed stream (i.e., a mixed stream of a hypercompressed fresh ethylene, high pressure ethylene recycle, and CTA and high pressure ethylene recycle). This second mixed stream may be introduced into the hypercompressor 120 that is sequentially connected to the booster/primary compressor 110, which is upstream of the hypercompressor 120, and sequentially connected to the autoclave reactor 130, which is downstream of the hypercompressor 120. At the hypercompressor 120, the second mixed stream is compressed further into a hypercompressed stream 121 that exits the hypercompressor 120.

The hypercompressed stream 121 is introduced into the autoclave reactor 130 that is sequentially connected to the hypercompressor 120, which is upstream from the autoclave reactor 130, and sequentially connected to tube reactor 140, which is downstream from the autoclave reactor 130. A side stream 122 is separated from the hypercompressed stream 121, such as, for example by a splitter (not shown) and introduced into the autoclave reactor 130 as a side stream 122. The side stream 122 and a portion of the hypercompressed stream 121 entering the autoclave reactor 130 may be in equal proportions. The portion of the hypercompressed stream 121 may be fed to the top of the autoclave reactor 130, such as zone one 130A of the autoclave reactor 130. The side stream 122 may be fed to the side of the autoclave reactor 130, such as zone two 130B. In the autoclave reactor 130, the hypercompressed stream 121 and the side stream 122 may be partially polymerized and exits the autoclave reactor 130 as stream 131. The stream 131 may then be fed to the tube reactor 140 that is sequentially connected to the autoclave reactor 130, which is upstream from the tube reactor 140, and sequentially connected to the high pressure separator 150, which is downstream from the tube reactor 140. In the tube reactor 140, stream 131 may be further polymerized and exits the tube reactor 140 as polymerized stream 141.

According to embodiments, the polymerization may be initiated in the autoclave reactor 130 and tube reactor 140 with the aid of four mixtures, each containing one or more free radical initiation systems that may be injected at the inlet of each reaction zone. A first peroxide initiator stream 124 may be introduced to zone one 130A of the autoclave reactor 130. A second peroxide initiator stream 123 may be introduced to zone two 130B of the autoclave reactor 130. A third peroxide initiator stream 125 may be introduced to zone three 130C of the autoclave reactor 130. Finally, a fourth peroxide initiator stream 132 may be introduced to the tube reactor 140.

The polymerized stream 141 is introduced into high pressure separator 150 that is sequentially connected to the tube reactor 140, which is upstream of the high pressure separator 150, and sequentially connected to a low pressure separator 160. At the high pressure separator 150, the polymerized stream 141 is separated into an ethylene rich stream 152 and a polymer rich stream 151. A first portion of the ethylene rich stream 153 is purged from the process reaction system 100 and a second portion of the ethylene rich stream 154 is cooled and recycled back to the hypercompressor 120, where the ethylene rich stream 152 is mixed with the compressed stream 111 that is introduced to the hypercompressor 120.

The polymer rich stream 151 is introduced to low pressure separator 160 that is sequentially connected to the high pressure separator 150, which is upstream of the low pressure separator 160, and is sequentially connected to the booster/primary compressor 110, which is downstream of the low pressure separator 160. At the low pressure separator 160, the polymer rich stream 151 is separated into a second polymer rich stream 161 and a second ethylene rich stream 162. The second polymer rich stream 161 exits the process reaction system 100, where it may be introduced to an extruder (not shown). The second ethylene rich stream 162 is mixed with the fresh ethylene feed stream 101 before being introduced to the booster/primary compressor 110 that is sequentially connected to the low pressure separator 160.

According to embodiments, initiators may be selected from the group consisting of t-butyl peroxypivalate (TBPIV), t-butyl peroxy-2 ethylhexanoate (TBPO), tert-butyl peroxyacetate (TBPA), di-tert-butyl peroxide (DTBP), and mixtures thereof.

### Low-Density Polyethylene Properties of Embodiments

A low-density polyethylene with enhanced melt strength and a desirable melt index and density or modulus is provided in embodiments disclosed and described herein. Properties of the low-density polyethylene according to embodiments disclosed and described herein will now be provided. Although the properties listed below are recited in separate paragraphs, it should be understood that any property from any paragraph below may be combined with any other property from any paragraph below by modifying the various process conditions discussed above. Therefore, low-density polyethylenes having any combination of various properties listed below are envisioned and can be produced according to embodiments.

According to embodiments, the low-density polyethylene may have a density of greater than or equal to 0.9210 and less than or equal to 0.9275 grams per cubic centimeter (g/cm³). Density measurements were made within one hour of sample pressing using ASTM D792-08, Method B. In embodiments, the low-density polyethylene has a density of greater than or equal to 0.9215 g/cm³ and less than or equal to 0.9270 g/cm³, greater than or equal to 0.9220 g/cm³ and less than or equal to 0.9265 g/cm³, greater than or equal to 0.9225 g/cm³ and less than or equal to 0.9260 g/cm³, greater than or equal to 0.9230 g/cm³ and less than or equal to 0.9255 g/cm³, greater than or equal to 0.9235 g/cm³ and less than or equal to 0.9250 g/cm³, or greater than or equal to 0.9240 g/cm³ and less than or equal to 0.9245 g/cm³.

In embodiments, the low-density polyethylene has a melt index (I₂)-measured according to ASTM D 1238 at 190° C. and at a load of 2.16 kg—that is greater than or equal to 4.5 grams per 10 minutes (g/10 min), such as greater than or equal to 4.6 g/10 min, greater than or equal to 4.7 g/10 min, greater than or equal to 4.8 g/10 min, greater than or equal to 4.9 g/10 min, greater than or equal to 5.0 g/10 min, greater than or equal to 5.1 g/10 min, greater than or equal to 5.2 g/10 min, greater than or equal to 5.3 g/10 min, greater than or equal to 5.4 g/10 min, greater than or equal to 5.5 g/10 min, greater than or equal to 5.6 g/10 min, greater than or equal to 5.7 g/10 min, greater than or equal to 5.8 g/10 min, greater than or equal to 5.9 g/10 min, or greater than or equal to 6.0 g/10 min. In embodiments, the melt index (I₂) is less than or equal to 7.5 g/10 min, such as less than or equal to 7.4 g/10 min, less than or equal to 7.3 g/10 min, less than or equal to 7.2 g/10 min, less than or equal to 7.1 g/10 min, less than or equal to 7.0 g/10 min, less than or equal to 6.9 g/10 min, less than or equal to 6.8 g/10 min, less than or equal to 6.7 g/10 min, less than or equal to 6.6 g/10 min, less than or equal to 6.5 g/10 min, less than or equal to 6.4 g/10 min, less than or equal to 6.3 g/10 min, less than or equal to 6.2 g/10 min, or less than or equal to 6.1 g/10 min. In embodiments the melt index (I₂) is greater than or equal to 4.5 g/10 min and less than or equal to 7.5 g/10 min, such as greater than or equal to 4.6 g/10 min and less than or equal to 7.5 g/10 min, greater than or equal to 4.7 g/10 min and less than or equal to 7.5 g/10 min, greater than or equal to 4.8 g/10 min and less than or equal to 7.5 g/10 min, greater than or equal to 4.9 g/10 min and less than or equal to 7.5 g/10 min, greater than or equal to 5.0 g/10 min and less than or equal to 7.5 g/10 min, greater than or equal to 5.1 g/10 min and less than or equal to 7.5 g/10 min, greater than or equal to 5.2 g/10 min and less than or equal to 7.5 g/10 min, greater than or equal to 5.3 g/10 min and less than or equal to 7.5 g/10 min, greater than or equal to 5.4 g/10 min and less than or equal to 7.5 g/10 min, greater than or equal to 5.5 g/10 min and less than or equal to 7.5 g/10 min, greater than or equal to 5.6 g/10 min and less than or equal to 7.5 g/10 min, greater than or equal to 5.7 g/10 min and less than or equal to 7.5 g/10 min, greater than or equal to 5.8 g/10 min and less than or equal to 7.5 g/10 min, greater than or equal to 5.9 g/10 min and less than or equal to 7.5 g/10 min, or greater than or equal to 6.0 g/10 min and less than or equal to 7.5 g/10 min. In embodiments, the melt index (I₂) is greater than or equal to 4.5 g/10 min and less than or equal to 7.0 g/10 min, such as greater than or equal to 5.0 g/10 min and less than or equal to 6.5 g/10 min, or about 6.0 g/10 min.

The melt strength is measured using a Rheotens attached to a capillary rheometer as disclosed below. In embodiments, the melt strength is greater than or equal to 5.5 centiNewtons (cN), such as greater than or equal to 5.6 cN, greater than or equal to 5.7 cN, greater than or equal to 5.8 cN, greater than or equal to 5.9 cN, greater than or equal to 6.0 cN, greater than or equal to 6.1 cN, greater than or equal to 6.2 cN, greater than or equal to 6.3 cN, greater than or equal to 6.4 cN, greater than or equal to 6.5 cN, greater than or equal to 6.6 cN, greater than or equal to 6.7 cN, greater than or equal to 6.8 cN, greater than or equal to 6.9 cN, greater than or equal to 7.0 cN, greater than or equal to 7.1 cN, greater than or equal to 7.2 cN, greater than or equal to 7.3 cN, greater than or equal to 7.4 cN, greater than or equal to 7.5 cN, greater than or equal to 7.6 cN, greater than or equal to 7.7 cN, greater than or equal to 7.8 cN, greater than or equal to 7.9 cN, greater than or equal to 8.0 cN, greater than or equal to 8.1 cN, greater than or equal to 8.2 cN , greater than or equal to 8.3 cN, or greater than or equal to 8.4 cN. In embodiments, the melt strength is greater than or equal to 5.5 cN and less than or equal to 8.5 cN, such as greater than or equal to 5.6 cN and less than or equal to 8.5 cN, greater than or equal to 5.7 cN and less than or equal to 8.5 cN, greater than or equal to 5.8 cN and less than or equal to 8.5 cN, greater than or equal to 5.9 cN and less than or equal to 8.5 cN, greater than or equal to 6.0 cN and less than or equal to 8.5 cN, greater than or equal to 6.1 cN and less than or equal to 8.5 cN, greater than or equal to 6.2 cN and less than or equal to 8.5 cN, greater than or equal to 6.3 cN and less than or equal to 8.5 cN, greater than or equal to 6.4 cN and less than or equal to 8.5 cN, greater than or equal to 6.5 cN and less than or equal to 8.5 cN, greater than or equal to 6.6 cN and less than or equal to 8.5 cN, greater than or equal to 6.7 cN and less than or equal to 8.5 cN, greater than or equal to 6.8 cN and less than or equal to 8.5 cN, greater than or equal to 6.9 cN and less than or equal to 8.5 cN, greater than or equal to 7.0 cN and less than or equal to 8.5 cN, greater than or equal to 7.1 cN and less than or equal to 8.5 cN, greater than or equal to 7.2 cN and less than or equal to 8.5 cN, greater than or equal to 7.3 cN and less than or equal to 8.5 cN, greater than or equal to 7.4 cN and less than or equal to 8.5 cN, greater than or equal to 7.5 cN and less than or equal to 8.5 cN, greater than or equal to 7.6 cN and less than or equal to 8.5 cN, greater than or equal to 7.7 cN and less than or equal to 8.5 cN, greater than or equal to 7.8 cN and less than or equal to 8.5 cN, greater than or equal to 7.9 cN and less than or equal to 8.5 cN, greater than or equal to 8.0 cN and less than or equal to 8.5 cN, greater than or equal to 8.1 cN and less than or equal to 8.5 cN, greater than or equal to 8.2 cN and less than or equal to 8.5 cN, greater than or equal to 8.3 cN and less than or equal to 8.5 cN, or greater than or equal to 8.4 cN and less than or equal to 8.5 cN. In embodiments, the melt strength is greater than or equal to 5.5 cN and less than or equal to 8.5 cN, such as greater than or equal to 5.5 cN and less than or equal to 8.3 cN, greater than or equal to 5.5 cN and less than or equal to 8.2 cN, greater than or equal to 5.5 cN and less than or equal to 8.1 cN, greater than or equal to 5.5 cN and less than or equal to 8.0 cN, greater than or equal to 5.5 cN and less than or equal to 7.9 cN, greater than or equal to 5.5 cN and less than or equal to 7.8 cN, greater than or equal to 5.5 cN and less than or equal to 7.7 cN, greater than or equal to 5.5 cN and less than or equal to 7.6 cN, greater than or equal to 5.5 cN and less than or equal to 7.5 cN, greater than or equal to 5.5 cN and less than or equal to 7.4 cN, greater than or equal to 5.5 cN and less than or equal to 7.3 cN, greater than or equal to 5.5 cN and less than or equal to 7.2 cN, greater than or equal to 5.5 cN and less than or equal to 7.1 cN, greater than or equal to 5.5 cN and less than or equal to 7.0 cN, greater than or equal to 5.5 cN and less than or equal to 6.9 cN, greater than or equal to 5.5 cN and less than or equal to 6.8 cN, greater than or equal to 5.5 cN and less than or equal to 6.7 cN, greater than or equal to 5.5 cN and less than or equal to 6.6 cN, greater than or equal to 5.5 cN and less than or equal to 6.5 cN, greater than or equal to 5.5 cN and less than or equal to 6.4 cN, greater than or equal to 5.5 cN and less than or equal to 6.3 cN, greater than or equal to 5.5 cN and less than or equal to 6.2 cN, greater than or equal to 5.5 cN and less than or equal to 6.1 cN, greater than or equal to 5.5 cN and less than or equal to 6.0 cN, greater than or equal to 5.5 cN and less than or equal to 5.9 cN, greater than or equal to 5.5 cN and less than or equal to 5.8 cN, greater than or equal to 5.5 cN and less than or equal to 5.7 cN, or greater than or equal to 5.5 cN and less than or equal to 5.6 cN. According to embodiments, the melt strength is greater than or equal to 5.5 cN and less than or equal to 8.5 cN, such as greater than or equal to 6.0 cN and less than or equal to 8.0 cN, greater than or equal to 6.0 cN and less than or equal to 7.5 cN, greater than or equal to 6.4 cN and less than or equal to 7.0 cN, or greater than or equal to 6.4 cN and less than or equal to 6.8 cN.

According to embodiments, the relationship between melt strength and melt index may be such that the melt strength measured at 190° C. in cN may be determined by the following expression:

$$M e l t S t r e n g t h \left(c N\right) \geq \left[- 0.780 ∗ \left(M e l t I n d e x , {I}_{2}\right) + 9.9 c N\right] \pm 5 \%$$

Alternatively, the melt strength measured at 190° C. may be determined by the following alternative expression:

$$M e l t S t r e n g t h \left(c N\right) \geq \left[- 0.780 ∗ \left(M e l t I n d e x , {I}_{2}\right) + 10.3 c N\right] \pm 5 \%$$

According to embodiments, the hexane extractables of the low-density polyethylene is less than or equal to 2.60 weight percent (wt%), such as less than or equal to 2.50 wt%, less than or equal to 2.40 wt%, less than or equal to 2.30 wt%, less than or equal to 2.20 wt%, less than or equal to 2.10 wt%, less than or equal to 2.00 wt%, less than or equal to 1.90 wt%, less than or equal to 1.80 wt%, less than or equal to 1.70 wt%, less than or equal to 1.60 wt%, less than or equal to 1.50 wt%, or less than or equal to 1.40 wt%. In embodiments, the extractables of the low-density polyethylene using a hexane method is greater than or equal to 0.50 wt% and less than or equal to 2.60 wt%, such as greater than or equal to 0.60 wt% and less than or equal to 2.50 wt%, greater than or equal to 0.70 wt% and less than or equal to 2.40 wt%, greater than or equal to 0.80 wt% and less than or equal to 2.30 wt%, greater than or equal to 0.90 wt% and less than or equal to 2.30 wt%, greater than or equal to 1.00 wt% and less than or equal to 2.20 wt%, greater than or equal to 1.10 wt% and less than or equal to 2.10 wt%, greater than or equal to 1.20 wt% and less than or equal to 2.00 wt%, greater than or equal to 1.20 wt% and less than or equal to 1.90 wt%, greater than or equal to 1.20 wt% and less than or equal to 1.80 wt%, greater than or equal to 1.20 wt% and less than or equal to 1.70 wt%, greater than or equal to 1.20 wt% and less than or equal to 1.60 wt%, greater than or equal to 1.20 wt% and less than or equal to 1.50 wt%, or about 1.40 wt%.

The number average molecular weight (Mn(conv))—measured by conventional GPC methods-of the low-density polyethylene is, according to embodiments, greater than or equal to 12,000 grams per mole (g/mol) and less than or equal to 18,500 g/mol, such as greater than or equal to 13,000 g/mol and less than or equal to 18,500 g/mol, greater than or equal to 14,000 g/mol and less than or equal to 17,000 g/mol, greater than or equal to 14,000 g/mol and less than or equal to 17,000 g/mol, or about 14,500 g/mol. The Mn(conv) is measured according to the gel permeation chromatography (GPC) protocols (conventional) disclosed herein.

The weight average molecular weight (Mw(conv))—measured by conventional GPC methods-of the low-density polyethylene is, according to embodiments, greater than or equal to 110,000 grams per mole (g/mol) and less than or equal to 140,000 g/mol, such as greater than or equal to 115,000 g/mol and less than or equal to 135,000 g/mol, greater than or equal to 117,500 g/mol and less than or equal to 130,000 g/mol, or about 125,000 g/mol. The Mw (conv) is measured according to the conventional GPC protocols disclosed herein.

The z-average molecular weight (Mz(conv))—measured by conventional GPC methods-of the low-density polyethylene is, according to embodiments, greater than or equal to 500,000 grams per mole (g/mol), such as greater than or equal to 500,000 g/mol and less than or equal to 650,000 g/mol, such as greater than or equal to 510,000 g/mol and less than or equal to 640,000 g/mol, greater than or equal to 520,000 g/mol and less than or equal to 630,000 g/mol, greater than or equal to 530,000 g/mol and less than or equal to 620,000 g/mol, greater than or equal to 540,000 g/mol and less than or equal to 610,000 g/mol, greater than or equal to 550,000 g/mol and less than or equal to 600,000 g/mol, greater than or equal to 560,000 g/mol and less than or equal to 590,000 g/mol, greater than or equal to 570,000 g/mol and less than or equal to 590,000 g/mol, or about 580,000 g/mol. The Mz (conv) is measured according to the conventional GPC protocols disclosed herein.

In embodiments, the molecular weight distribution (Mw(conv)/Mn(conv))— measured according to conventional GPC methods-of the low-density polyethylene is greater than or equal to 7.2, such as greater than or equal to 7.3, greater than or equal to 7.4, or greater than or equal to 7.5. In embodiments, Mw (conv)/Mn (conv) is less than or equal to 9.5, such as less than or equal to 9.0, less than or equal to 8.8, less than or equal to 8.6, or less than or equal to 8.2.

The weight average molecular weight Mw (abs)—measured according to absolute methods provided below—of the low-density polyethylene is, according to embodiments, greater than or equal to 225,000 g/mol and less than or equal to 325,000 g/mol, greater than or equal to 235,000 g/mol and less than or equal to 315,000 g/mol, greater than or equal to 245,000 g/mol and less than or equal to 305,000 g/mol, greater than or equal to 255,000 g/mol and less than or equal to 295,000 g/mol, greater than or equal to 265,000 g/mol and less than or equal to 285,000 g/mol, or about 275,000 g/mol. The Mw (abs) is measured according to the absolute GPC protocols disclosed herein.

The ratio of weight average molecular weight measured according to absolute methods to weight average molecular weight measured according to conventional GPC methods (Mw (abs)/ Mw (conv)) disclosed herein of the low-density polyethylene is, according to embodiments, greater than or equal to 2.1 and less than or equal to 2.7, such as greater than or equal to 2.1 and less than or equal to 2.4, or greater than or equal to 2.15 and less than or equal to 2.35.

According to embodiments, the GPC branching ratio (gpcBR) of the low-density polyethylene—measured with the absolute techniques disclosed herein—is greater than or equal to 2.3 and less than or equal to 3.2, such as greater than or equal to 2.4 and less than or equal to 3.1, greater than or equal to 2.5 and less than or equal to 3.0, or greater than or equal to 2.6 and less than or equal to 2.9.

The light scattering property (LSP) of the low-density polyethylene is, according to embodiments, less than 3.8, such as less than or equal to 3.7, less than or equal to 3.6, or less than or equal to 3.5. In embodiments, the LSP is greater than or equal to 2.5, greater than or equal to 2.6, or greater than or equal to 2.7. In embodiments, the LSP is greater than or equal to 2.5 and less than or equal to 3.5, such as greater than or equal to 2.6 and less than or equal to 3.4, or greater than or equal to 2.7 and less than or equal to 3.3.

In embodiments, the low-density polyethylene has a viscosity measured at 0.1 radians/second (rad/sec) and 190° C. that is greater than or equal to 2,250 Pa·s and less than or equal to 4,250 Pa·s, such as greater than or equal to 2,400 Pa·s and less than or equal to 4,000 Pa·s, greater than or equal to 2,600 Pa·s and less than or equal to 3,800 Pa·s, greater than or equal to 2,800 Pa·s and less than or equal to 3,600 Pa·s, or greater than or equal to 2,900 Pa·s and less than or equal to 3,400 Pa·s, or about 3,200 Pa·s. The viscosity is measured according the protocols disclosed herein.

In embodiments, the low-density polyethylene has a viscosity measured at 100 radians/second (rad/sec) and 190° C. that is greater than or equal to 250 Pa·s and less than or equal to 400 Pa·s, such as greater than or equal to 270 Pa·s and less than or equal to 380 Pa·s, greater than or equal to 290 Pa·s and less than or equal to 360 Pa·s, or about 320 Pa·s. The viscosity is measured according the protocols disclosed herein.

In embodiments, the low-density polyethylene has a ratio of viscosity measured at 0.1 radians/second and 190° C. to viscosity measured at 100 radians/second and 190° C. (V@0.1/V@100 and 190° C.) that is greater than or equal to 8.0, such as greater than or equal to 8.5, greater than or equal to 9.0, or greater than or equal to 9.5. In embodiments, a ratio of viscosity measured at 0.1 radians/second and 190° C. to viscosity measured at 100 radians/second and 190° C. is greater than or equal to 8.0 and less than or equal to 12.0, such as greater than or equal to 8.5 and less than or equal to 11.0, greater than or equal to 9.0 and less than or equal to 10.5, or greater than or equal to 9.2 and less than or equal to 10.8.

In embodiments, the cumulative distribution fraction (CDF) for infrared spectrum analysis (CDF_{IR}) at a molecular weight less than 5,000 g/mol is less than or equal to 0.081, such as less than or equal to 0.079, less than or equal to 0.077, less than or equal to 0.075, less than or equal to 0.073, or less than or equal to 0.071. In embodiments, the CDF_{IR} at a molecular weight less than 5,000 g/mol is greater than or equal to 0.040 and less than or equal to 0.081, such as greater than or equal to 0.040 such as greater than or equal to 0.055 and less than or equal to 0.079, greater than or equal to 0.055 and less than or equal to 0.077, greater than or equal to 0.055 and less than or equal to 0.075, greater than or equal to 0.055 and less than or equal to 0.075.

In embodiments, the CDF_{IR} at a molecular weight greater than 200,000 g/mol is greater than or equal to 0.135, such as greater than or equal to 0.145, greater than or equal to 0.150, greater than or equal to 0.155, or greater than or equal to 0.160. In embodiments, the CDF_{IR} at a molecular weight greater than 200,000 g/mol is greater than or equal to 0.135 and less than or equal to 0.180, such as greater than or equal to 0.145 and less than or equal to 0.175, greater than or equal to 0.150 and less than or equal to 0.170, or greater than or equal to 0.155 and less than or equal to 0.163.

In embodiments, the CDF for viscometer analysis (CDF_{Dv}) at a molecular weight less than 25,000 g/mol is less than or equal to 0.130, such as less than or equal to 0.127, less than or equal to 0.126, less than or equal to 0.125, less than or equal to 0.123, less than or equal to 0.121, or less than or equal to 0.119. In embodiments, the CDF_{DV} at a molecular weight less than 25,000 g/mol is greater than or equal to 0.050 and less than or equal to 0.130, such as greater than or equal to 0.100 and less than or equal to 0.128, greater than or equal to 0.110 and less than or equal to 0.125, or greater than or equal to 0.115 and less than or equal to 0.126.

In embodiments, the CDF_{DV} at a molecular weight greater than 1,000,000 g/mol is greater than or equal to 0.042, such as greater than or equal to 0.048, greater than or equal to 0.053, greater than or equal to 0.058, or greater than or equal to 0.061. In embodiments, the CDF_{DV} at a molecular weight greater than 1,000,000 g/mol is greater than or equal to 0.042 and less than or equal to 0.070, such as greater than or equal to 0.048 and less than or equal to 0.065, or greater than or equal to 0.053 and less than or equal to 0.064.

In embodiments, the cumulative distribution fractions (CDF) for light scattering analysis (CDF_{LS}) at a molecular weight less than 100,000 g/mol is less than or equal to 0.140, such as less than or equal to 0.130, less than or equal to 0.120, or less than or equal to 0.110. In embodiments, CDF_{LS} at a molecular weight less than 100,000 g/mol is greater than or equal to 0.075 and less than or equal to 0.140, such as greater than or equal to 0.085 and less than or equal to 0.130, or greater than or equal to 0.095 and less than or equal to 0.115.

In embodiments, the CDF_{LS} at a molecular weight greater than 1,500,000 g/mol is greater than or equal to 0.110, such as greater than or equal to 0.120, greater than or equal to 0.130, greater than or equal to 0.135, greater than or equal to 0.140, or greater than or equal to 0.145. In embodiments, the CDF_{LS} at a molecular weight greater than 1,500,000 g/mol is greater than or equal to 0.110 and less than or equal to 0.160, such as greater than or equal to 0.120 and less than or equal to 0.155, or greater than or equal to 0.130 and less than or equal to 0.155.

In embodiments, the low-density polyethylene has greater than or equal to 1.5 amyl groups (C₅) per 1000 total carbon atoms and less than or equal to 3.0 amyl groups (C₅) per 1000 total carbon atoms, as determined by ¹³CNMR.

In embodiments, the polymer has no C₁ branches (methyl branches) per 1000 total carbon atoms.

In embodiments, the low-density polyethylene has greater than or equal to 1.5 1,3 diethyl branches per 1000 total carbon atoms and less than or equal to 5.0 of 1,3 diethyl branches per 1000 total carbon atoms.

In embodiments, the low-density polyethylene has greater than or equal to 3.0 and less than or equal to 4.0 of C₆+ branches per 1000 total carbon atoms.

In embodiments, the low-density polyethylene has greater than or equal to 0.018 vinyls per 1000 total carbon atoms and less than or equal to 0.043 vinyls per 1000 total carbon atoms.

In embodiments, the low-density polyethylene has greater than or equal to 0.01 cis and trans groups (vinylene) per 1000 total carbon atoms and less than or equal to 0.03 cis and trans groups (vinylene) per 1000 total carbon atoms.

In embodiments, the low-density polyethylene has greater than or equal to 0.05 vinylidene per 1000 total carbon atoms and less than or equal to 0.25 vinylidene per 1000 total carbon atoms.

### Additives

Compositions of embodiments may comprise one or more additives. Additives include, stabilizers, plasticizers, antistatic agents, pigments, dyes, nucleating agents, fillers, slip agents (such as erucamide, oleamide, and stearamide), fire retardants, processing aids, smoke inhibitors, viscosity control agents, anti-blocking agents (including talc and silicon dioxide), and oils, such as mineral oils. The polymer composition may, for example, comprise less than 10 percent (by the combined weight) of one or more additives, based on the weight of the low-density polyethylene of embodiments. In embodiments, the low-density polyethylene may be treated with one or more stabilizers, for example, antioxidants, such as IRGANOX 1010, IRGANOX 1076 and IRGAFOS 168 (BASF). It should be understood that in embodiments, no stabilizers are used.

Blends and mixtures of the low-density polyethylene of the embodiments with other polymers may be performed. Suitable polymers for blending with the low-density polyethylene of the embodiments include natural and synthetic polymers. Exemplary polymers for blending include propylene-based polymers (both impact modifying polypropylene, isotactic polypropylene, atactic polypropylene, and random ethylene/propylene copolymers), various types of ethylene-based polymers, including high pressure, free-radical LDPE, LLDPE prepared with Ziegler-Natta catalysts, PE prepared with single site catalysts, including multiple reactor PE (“in reactor” blends of Ziegler-Natta PE and single site catalyzed PE, such as products disclosed in USP 6,545,088 (Kolthammer et al.); 6,538,070 (Cardwell, et al.); 6,566,446 (Parikh, et al.); 5,844,045 (Kolthammer et al.); 5,869,575 (Kolthammer et al.); and 6,448,341 (Kolthammer et al.)), EVA, ethylene/vinyl alcohol copolymers, polystyrene, impact modified polystyrene, ABS, styrene/butadiene block copolymers and hydrogenated derivatives thereof (SBS and SEBS), and thermoplastic polyurethanes. Homogeneous polymers, such as olefin plastomers and elastomers, ethylene and propylene-based copolymers (for example, polymers available under the trade designation VERSlFY™ Plastomers & Elastomers (The Dow Chemical Company) and VISTAMAXX (ExxonMobil Chemical Co.) can also be useful as components in blends comprising the low-density polyethylene of embodiments). LLDPE’s such as INNATE™, DOWLEX™, and DOWLEX™ GM (The Dow Chemical Company) and Exceed and Exceed XP (Exxon Chemical Company) may also be used.

Additives such as slip additives, antioxidants, or antiblocks can affect resin properties. Additionally, oils, such as mineral oil, which may be used as carriers for additives may also affect resin properties. A low-density polyethylene may be analyzed to determine the presence of additives with various methods, including a slip additive method, a primary and secondary antioxidant method, an antiblock method, and a mineral oil method, further described below.

The presence of additives may have an effect on molecular weight, the hexane extractables, and density. For example, low molecular weight properties of additives may decrease the molecular weight of the ethylene-based polymer. Therefore, as detailed herein, in the low molecular weight region of the GPC elution curve, when a peak exists that is known to be caused by the presence of an antioxidant or other additive, the presence of such a peak may cause an underestimation of the number average molecular weight (Mn) of the polymer sample to give a overestimation of the sample polydispersity defined as Mw/Mn, where Mw is the weight average molecular weight. Similarly, when additives are present, a hexane extractables measurement would include all hexane soluble additives, but the hexane extractables measurement would not include additives that are not soluble in hexane, such as antiblocks. Therefore, the percent hexane extractables of a resin with additives would be equal to the sum of the percent hexane extractables of the additive-free ethylene-based polymer and the percentage of the hexane-soluble additives (such as slip agents and antioxidants) and/or any hexane-soluble oils (such as may be used as a carrier for additives). Finally, additives, such as antiblocks, may increase the density of the ethylene-based polymer. The density (in g/cm³) of an ethylene-based polymer free of any additive (where the additive is an antiblock such as talc or silicon dioxide) may be expressed by the following expression:

$$\begin{matrix}D e n s i t y o f A d d i t i v e F r e e P o l y m e r \left(\frac{g}{c {m}^{3}}\right) \\ = D e n s i t y o f P o l y m e r w i t h A n t i b l o c k \left(\frac{g}{c {m}^{3}}\right) - \\ \left(0.0006 \left(\frac{g}{c {m}^{3}}\right)\right) ∗ \left(\frac{p p m o f a d d i t i v e}{1000}\right)\end{matrix}$$

### Applications

The low-density polyethylene of the embodiments may be employed in a variety of conventional thermoplastic fabrication processes to produce useful articles, including monolayer and multilayer films; molded articles, such as blow molded, injection molded, cast molded, or rotomolded articles; coatings; fibers; and woven or non-woven fabrics. The low-density polyethylene of the embodiments may be used in a variety of films, including but not limited to, extrusion coating, food packaging, consumer, industrial, agricultural (applications or films), lamination films, fresh cut produce films, cast films, blown films, thermoformed films, meat films, cheese films, candy films, clarity shrink films, collation shrink films, stretch films, silage films, greenhouse films, fumigation films, liner films, stretch hood, heavy duty shipping sacks, pet food, sandwich bags, sealants, and diaper backsheets.

The low-density polyethylene of the embodiments is also useful in other direct end-use applications. The low-density polyethylene of embodiments may be used for wire and cable coating operations, in sheet extrusion for vacuum forming operations, and forming molded articles, including the use of injection molding, blow molding, or rotomolding processes. Other suitable applications for the low-density polyethylene of embodiments include elastic films and fibers; soft touch goods, such as appliance handles; gaskets and profiles; auto interior parts and profiles; foam goods (both open and closed cell); impact modifiers for other thermoplastic polymers, such as high density polyethylene, or other olefin polymers; cap liners; and flooring.

In embodiments disclosed and described herein, the low-density polyethylene is an additive-free low-density polyethylene, unless explicitly referred to otherwise, and the properties disclosed herein are in reference to additive-free low-density polyethylene unless otherwise disclosed.

### Test Methods

The testing methods include the following:

### Density

Samples for density measurements were prepared according to ASTM D 4703-10. Samples were pressed at 374° F. (190° C.), for five minutes, at 10,000 psi (68 MPa). The temperature was maintained at 374° F. (190° C.) for the above five minutes, and then the pressure was increased to 30,000 psi (207 MPa) for three minutes. This was followed by a one minute hold at 70° F. (21° C.) and 30,000 psi (207 MPa). Measurements were made within one hour of sample pressing using ASTM D792-08, Method B.

### Melt Index

Melt flow index, or Melt index or I₂, was measured in accordance with ASTM D 1238-10, Condition 190° C./2.16 kg, Method B, and was reported in grams eluted per 10 minutes.

### Nuclear Magnetic Resonance (¹³C NMR)

Samples were prepared by adding approximately “3g″ of 1,1,2,2-tetrachloroethane (TCE) containing 12 wt% TCE-d2 and 0.025 M Cr(AcAc)₃,” to a “0.25 to 0.40 g” polymer sample, in a 10 mm NMR tube. Oxygen was removed from the sample by purging the headspace with nitrogen. The samples were then dissolved, and homogenized by heating the tube and its contents to 120-140° C. using a heating block and heat gun. Each dissolved sample was visually inspected to ensure homogeneity. Samples were thoroughly mixed immediately prior to analysis and were not allowed to cool before insertion into the heated NMR sample holders.

All data were collected using a Bruker 600 MHz spectrometer equipped with a 10 mm extended temperature cryoprobe. The data was acquired using a 7.8 second pulse repetition delay, 90-degree flip angles, and inverse gated decoupling, with a sample temperature of 120° C. All measurements were made on non-spinning samples in locked mode. Samples were allowed to thermally equilibrate for seven minutes prior to data acquisition. The 13C NMR chemical shifts were internally referenced to the EEE triad at 30.0 ppm. The “C₆+” value is a direct measure of C₆+ branches in a low-density polyethylene, where the long branches are not distinguished from “chain ends.” The “32.2 ppm” peak, representing the third carbon from the end of all chains or branches of six or more carbons, is used to determine the “C₆+” value.

TABLE 1

Branching Type and 13C NMR integral ranges used for quantitation

| | | |
|---|---|---|
| Branch Type | Peak(s) Integrated | Identity of the Integrated Carbon Peak(s) |
| 1,3 diethyl | about 10.5 to 11.5 ppm | 1,3 diethyl branch methyls |
| C₂ on Quaternary Carbon | about 7.5 to 8.5 ppm | 2 ethyl branches on a quaternary carbon, methyls |
| C₁ | about 19.75 to 20.50 ppm | C₁, methyl branches |
| C₄ | about 23.3 to 23.5 ppm | Second CH₂ in a 4-carbon branch, counting the methyl as the first C |
| C₅ | about 32.60 to 32.80 ppm | Third CH₂ in a 5-carbon branch, counting the methyl as the first C |
| or C₆+ | About 32.1 to 32.3 ppm | The third CH₂ (counting the methyl as the first C) in any branch of 6 or more carbons in length |

### Nuclear Magnetic Resonance (¹HNMR)

The samples were prepared by adding approximately 120 mg of sample to “3.25 g of 50/50, by weight, tetrachlorethane-d2/perchloroethylene” with 0.001 M Cr(AcAc)₃, in a 10 mm NMR tube. The samples were purged by bubbling N₂ through the solvent, via a pipette inserted into the tube, for approximately five minutes, to prevent oxidation. Each tube was capped and sealed with TEFLON tape. The samples were heated and vortexed at 110 - 115° C. to ensure homogeneity.

The ¹HNMR was performed on a Bruker 600 MHz spectrometer equipped with a 10 mm extended temperature cryoprobe. The data was acquired with ZG pulse, 64 scans, a 15.8 second pulse repetition delay and a sample temperature of 120° C.

The signal from the whole polymer, about 3 to -0.5 ppm, was set to an arbitrary value, typically 20,000. The corresponding integrals for unsaturation (vinylene at about 5.40 to 5.60 ppm, trisubstituted at about 5.16 to 5.35 ppm, vinyl at about 4.95 to 5.15 ppm, and vinylidene at about 4.70 to 4.90 ppm) were obtained.

The integral of the whole polymer from the control experiment was divided by two, to obtain a value representing X thousands of carbons (i.e., if the polymer integral = 20,000, this represents 10,000 carbons, and X=10).

The unsaturated group integrals, divided by the corresponding number of protons contributing to that integral, represent the moles of each type of unsaturation per X thousand carbons. Dividing the moles of each type of unsaturation by X, then gives the moles of unsaturated groups per 1000 moles of carbons.

### Melt Strength

Melt strength measurements were conducted on a Göttfert Rheotens 71.97 (Göttfert Inc.; Rock Hill, SC), attached to a Göttfert Rheotester 2000 capillary rheometer. The melted sample (about 25 to 30 grams) was fed with a Göettfert Rheotester 2000 capillary rheometer, equipped with a flat entrance angle (180 degrees) of length of 30 mm, diameter of 2.0 mm, and an aspect ratio (length/diameter) of 15. After equilibrating the samples at 190° C. for 10 minutes, the piston was run at a constant piston speed of 0.265 mm/second. The standard test temperature was 190° C. The sample was drawn uniaxially to a set of accelerating nips, located 100 mm below the die, with an acceleration of 2.4 mm/s². The tensile force was recorded as a function of the take-up speed of the nip rolls. Melt strength was reported as the average plateau force (cN) before the strand broke. The following conditions were used in the melt strength measurements: plunger speed = 0.265 mm/second; wheel acceleration = 2.4 mm/s²; capillary diameter = 2.0 mm; capillary length = 30 mm; and barrel diameter = 12 mm.

### Dynamic Mechanical Spectroscopy (DMS)

Resins were compression-molded into “3 mm thick × 1 inch” circular plaques at 177° C., for five minutes, under 25,000 psi pressure, in air. The sample was then taken out of the press, and placed on a counter to cool.

A constant temperature frequency sweep was performed using a TA Instruments “Advanced Rheometric Expansion System (ARES),” equipped with 25 mm (diameter) parallel plates, under a nitrogen purge. The sample was placed on the plate, and allowed to melt for five minutes at 190° C. The plates were then closed to a gap of “2 mm,” the sample trimmed (extra sample that extends beyond the circumference of the “25 mm diameter” plate was removed), and then the test was started. The method had an additional five minute delay built in, to allow for temperature equilibrium. The experiments were performed at 190° C. over a frequency range of 0.1 to 100 rad/s. The strain amplitude was constant at 10%. The complex viscosity η*, tan (δ) or tan delta, viscosity at 0.1 rad/s (V0.1), the viscosity at 100 rad/s (V100), and the viscosity ratio (V0.1/V100) were calculated from these data.

### GPC

### Triple Detector Gel Permeation Chromatography (TDGPC)

The chromatographic system consisted of a PolymerChar GPC-IR (Valencia, Spain) high temperature GPC chromatograph equipped with an internal IR5 infra-red detector (IR5) and 4-capillary viscometer (DV) coupled to a Precision Detectors (Now Agilent Technologies) 2-angle laser light scattering (LS) detector Model 2040. For all Light scattering measurements, the 15 degree angle is used for measurement purposes. The autosampler oven compartment was set at 160° C. and the column compartment was set at 150° C. The columns used were 4 Agilent “Mixed A” 30 cm 20-micron linear mixed-bed columns and a 20-um pre-column. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration and calculation of the conventional molecular weight moments and the distribution (using the 20 um “Mixed A” columns) were performed according to the method described in the Conventional GPC procedure.

The Systematic Approach for the determination of multi-detector offsets is done in a manner consistent with that published by Balke, Mourey, et. al. (Mourey and Balke, Chromatography Polym. Chpt 12, (1992)) (Balke, Thitiratsakul, Lew, Cheung, Mourey, Chromatography Polym. Chpt 13, (1992)), optimizing triple detector log (MW and IV) results from a broad homopolymer polyethylene standard (Mw/Mn > 3) to the narrow standard column calibration results from the narrow standards calibration curve using PolymerChar GPCOne™ Software. As used herein, “MW” refers to molecular weight.

The absolute molecular weight data was obtained in a manner consistent with that published by Zimm (Zimm, B.H., J. Chem. Phys., 16, 1099 (1948)) and Kratochvil (Kratochvil, P., Classical Light Scattering from Polymer Solutions, Elsevier, Oxford, NY (1987)) using PolymerChar GPCOne™software. The overall injected concentration, used in the determination of the molecular weight, was obtained from the mass detector area and the mass detector constant, derived from a suitable linear polyethylene homopolymer, or one of the polyethylene standards of known weight-average molecular weight. The calculated molecular weights (using GPCOne™) were obtained using a light scattering constant, derived from one or more of the polyethylene standards mentioned below, and a refractive index concentration coefficient, dn/dc, of 0.104. Generally, the mass detector response (IR5) and the light scattering constant (determined using GPCOne™)should be determined from a linear standard with a molecular weight in excess of about 50,000 g/mole. The viscometer calibration (determined using GPCOne™)can be accomplished using the methods described by the manufacturer, or, alternatively, by using the published values of suitable linear standards, such as Standard Reference Materials (SRM) 1475a (available from National Institute of Standards and Technology (NIST)). A viscometer constant (obtained using GPCOne™)is calculated which relates specific viscosity area (DV) and injected mass for the calibration standard to its intrinsic viscosity (IV). The chromatographic concentrations are assumed low enough to eliminate addressing 2nd viral coefficient effects (concentration effects on molecular weight).

The absolute weight average molecular weight (Mw(Abs)) is obtained (using GPCOne™)from the Area of the Light Scattering (LS) integrated chromatogram (factored by the light scattering constant) divided by the mass recovered from the mass constant and the mass detector (IR5) area. The molecular weight and intrinsic viscosity responses are extrapolated at chromatographic ends where signal to noise becomes low (using GPCOne™). Other respective moments, Mn(_{Abs}) and Mz(_{Abs}) are be calculated according to equations 1-2 as follows:

$$M {n}_{\left(A b s\right)} = \frac{{\sum }_{}^{i} I {R}_{i}}{{\sum }_{}^{i} \left(\frac{I {R}_{i}}{{M}_{A b s o l u t e i}}\right)}$$

$$M {z}_{\left(A b s\right)} = \frac{{\sum }_{}^{i} \left(I {R}_{i} ∗ {M}_{A b s o l u t e i} {}^{2}\right)}{{\sum }_{}^{i} \left(I {R}_{i} ∗ {M}_{A b s o l u t e i}\right)}$$

### Conventional GPC

The chromatographic system consisted of a PolymerChar GPC-IR (Valencia, Spain) high temperature GPC chromatograph equipped with an internal IR5 infra-red detector (IR5) coupled to a Precision Detectors (Now Agilent Technologies) 2-angle laser light scattering (LS) detector Model 2040. For all Light scattering measurements, the 15 degree angle is used for measurement purposes. The autosampler oven compartment was set at 160° C. and the column compartment was set at 150° C. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 g/mol to 8,400,000 g/mol and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000 g/mol, and 0.05 grams in 50 milliliters of solvent for molecular weights less than 1,000,000 g/mol. The polystyrene standards were dissolved at 80° C. with gentle agitation for 30 minutes. The polystyrene standard peak molecular weights were converted to polyethylene molecular weights using Equation 1 (as described in Williams and Ward, J. Polym. Sci., Polym. Let., 6, 621 (1968)):

$$M {W}_{p o l y e t h y l e n e} = A \times {\left(M {w}_{p o l y s t y r e n e}\right)}^{B}$$

where MW is the molecular weight, A has a value of 0.4315 and B is equal to 1.0.

A fifth order polynomial was used to fit the respective polyethylene-equivalent calibration points. A small adjustment to A (from approximately 0.3950 to 0.440) was made to correct for column resolution and band-broadening effects such that such that linear homopolymer polyethylene standard is obtained at 120,000 Mw .

The total plate count of the GPC column set was performed with decane (prepared at 0.04 g in 50 milliliters of TCB.) The plate count (Equation 4) and symmetry (Equation 5) were measured on a 200 microliter injection according to the following equations:

$$P l a t e C o u n t = 5.54 ∗ {\left(\frac{{\text{RV}}_{\text{Peak} \text{Max}}}{P e a k W i d t h a t \frac{1}{2} h e i g h t}\right)}^{2}$$

where RV is the retention volume in milliliters, the peak width is in milliliters, the peak max is the maximum height of the peak, and ½ height is ½ height of the peak maximum.

$$S y m m e t r y = \frac{\left(R e a r P e a k R {V}_{o n e t e n t h h e i g h t} - R {V}_{P e a k m a x}\right)}{\left(R {V}_{P e a k m a x} - F r o n t P e a k R {V}_{o n e t e n t h h e i g h t}\right)}$$

where RV is the retention volume in milliliters and the peak width is in milliliters, Peak max is the maximum position of the peak, one tenth height is ⅒ height of the peak maximum, and where rear peak refers to the peak tail at later retention volumes than the peak max and where front peak refers to the peak front at earlier retention volumes than the peak max. The plate count for the chromatographic system should be greater than 20,000 and symmetry should be between 0.98 and 1.22.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° C. under “low speed” shaking.

The calculations of Mn(conv), Mw(conv), and Mz(conv) were based on GPC results using the internal IR5 detector (measurement channel) of the PolymerChar GPC-IR chromatograph according to Equations 6-8, using PolymerChar GPCOne™software, the baseline-subtracted IR chromatogram at each equally-spaced data collection point (i), and the polyethylene equivalent molecular weight obtained from the narrow standard calibration curve for the point (i) from Equation 1.

$$M n \left(c o n v\right) = \frac{\sum {}^{i} I {R}_{i}}{\sum {}^{i} \left(\frac{I {R}_{i}}{{M}_{p o l y e t h y l e n {e}_{i}}}\right)}$$

$$M w \left(c o n v\right) = \frac{\sum {}^{i} \left(I {R}_{i} ∗ {M}_{p o l y e t h y l e n {e}_{i}}\right)}{\sum {}^{i} I {R}_{i}}$$

$$M z \left(c o n v\right) = \frac{\sum {}^{i} \left(I {R}_{i} ∗ {M}_{p o l y e t h y l e n {e}_{i}} {}^{2}\right)}{\sum {}^{i} \left(I {R}_{i} ∗ {M}_{p o l y e t h y l e n {e}_{i}}\right)}$$

In the low molecular weight region of the GPC elution curve, when a peak exists that is known to be caused by the presence of anti-oxidant or other additives, the presence of such a peak will cause an underestimation of the number average molecular weight (Mn) of the polymer sample to give a overestimation of the sample polydispersity defined as Mw/Mn, where Mw is the weight average molecular weight. The true polymer sample molecular weight distribution should therefore be calculated from the GPC elution by excluding this extra peak. This process is commonly described as the peak skim feature in data processing procedures in liquid chromatographic analyses. In this process, this additive peak is skimmed off from the GPC elution curve before the sample molecular weight calculation is performed from the GPC elution curve. The plate count for the chromatographic system should be greater than 24,000 and symmetry should be between 0.98 and 1.22.

In order to monitor the deviations over time, a flowrate marker (decane) was introduced into each sample via a micropump controlled with the PolymerChar GPC-IR system. This flowrate marker (FM) was used to linearly correct the pump flowrate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flowrate (with respect to the narrow standards calibration) is calculated as Equation 9. Processing of the flow marker peak was done via the PolymerChar GPCOne™Software. Acceptable flowrate correction is such that the effective flowrate should be within +/-1% of the nominal flowrate.

$$\begin{matrix}\text{Flowrate} \left(\text{effective}\right) = \\ \text{Flowrate} \left(\text{nominal}\right) ∗ \left(\text{RV} \left(\text{FM} \text{Calibrated}\right) / \text{RV} \left(\text{FM} \text{Sample}\right)\right)\end{matrix}$$

The Systematic Approach for the determination of multi-detector offsets is done in a manner consistent with that published by Balke, Mourey, et. al. (Mourey and Balke, Chromatography Polym. Chpt 12, (1992)) (Balke, Thitiratsakul, Lew, Cheung, Mourey, Chromatography Polym. Chpt 13, (1992)), optimizing triple detector log (MW and IV) results from a broad homopolymer polyethylene standard (Mw/Mn > 3) to the narrow standard column calibration results from the narrow standards calibration curve using PolymerChar GPCOne™ Software.

The absolute molecular weight data was obtained in a manner consistent with that published by Zimm (Zimm, B.H., J. Chem. Phys., 16, 1099 (1948)) and Kratochvil (Kratochvil, P., Classical Light Scattering from Polymer Solutions, Elsevier, Oxford, NY (1987)) using PolymerChar GPCOne™software. The overall injected concentration, used in the determination of the molecular weight, was obtained from the mass detector area and the mass detector constant, derived from a suitable linear polyethylene homopolymer, or one of the polyethylene standards of known weight-average molecular weight. The calculated molecular weights (using GPCOne™) were obtained using a light scattering constant, derived from one or more of the polyethylene standards mentioned below, and a refractive index concentration coefficient, dn/dc, of 0.104. Generally, the mass detector response (IR5) and the light scattering constant (determined using GPCOne™)should be determined from a linear standard with a molecular weight in excess of about 50,000 g/mol.

### CDF Calculation Method

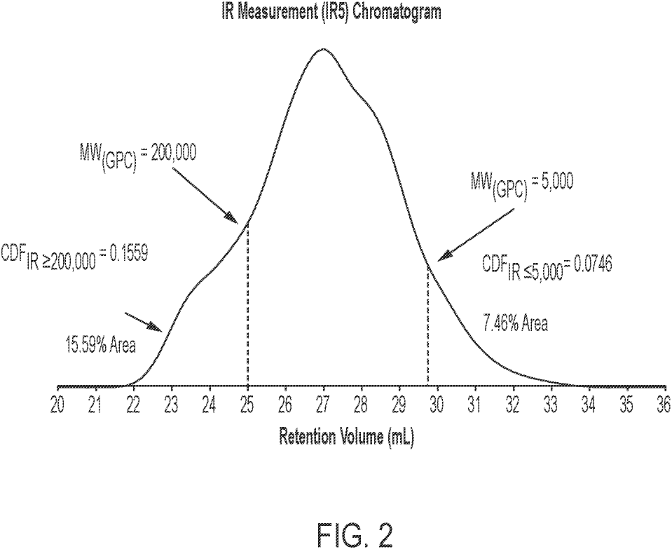

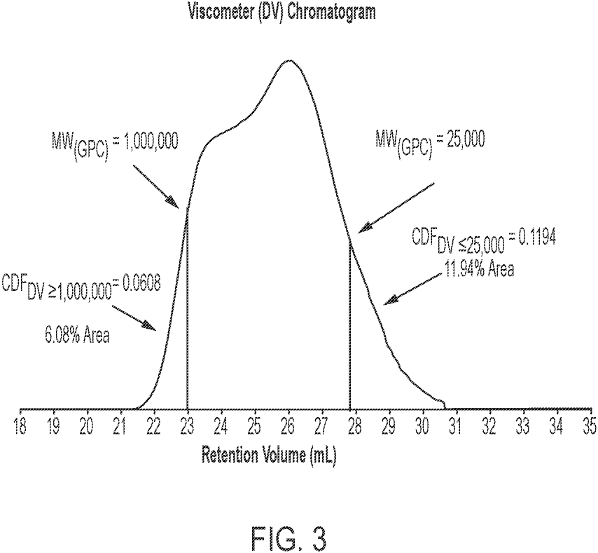

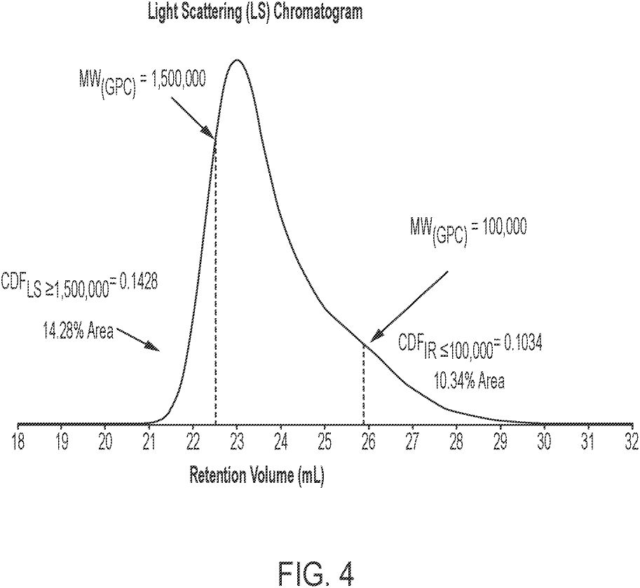

The calculation of the cumulative detector fractions (CDF) for the IR5 measurement detector (“CDF_{IR}”), cumulative detector factions from the viscosity detector (“CDF_{Dv}”) and the low angle laser light scattering detector (“CDF_{LS}”) are accomplished by the following steps (Visually Represented as FIG. 2, FIG. 3, and FIG. 4 for CDF_{IR}, CDF_{DV}, and CDF_{LS}):
1) Linearly flow correct the chromatogram based on the relative retention volume ratio of the air peak between the sample and that of a consistent narrow standards cocktail mixture.
2) Correct the light scattering detector offset relative to the refractometer as described in the Gel Permeation Chromatography (GPC) section.
3) Calculate the molecular weights at each retention volume (RV) data slice based on the polystyrene calibration curve, modified by the polystyrene to polyethylene conversion factor of approximately (0.3950-0.44) as described in the Gel Permeation Chromatography (GPC) section.
4) Subtract baselines from the light scattering and refractometer chromatograms and set integration windows using standard GPC practices making certain to integrate all of the low molecular weight retention volume range in the light scattering chromatogram that is observable from the refractometer chromatogram (thus setting the highest RV limit to the same index in each chromatogram). Do not include any material in the integration which corresponds to less than 150 g/mol in either chromatogram.
5) Calculate the cumulative detector fraction (CDF) of the IR5 Measurement sensor (CDF_{IR}), viscosity chromatogram (CDF_{Dv}) and Low-Angle Laser Light Scattering (LALLS) chromatogram (CDF_{LS}) based on its baseline-subtracted peak height (H) from high to low molecular weight (low to high retention volume) at each data slice (j) according to Equations 10A, 10B, 10C, 10D, 10E, and 10F and shown in FIG. 2, FIG. 3 and FIG. 4 for Example 1:
$$C D {F}_{I R \leq 5 , 0 0 0 M W} = \frac{{\sum }_{j = R V a t 5 , 0 0 0 M W}^{j = R V a t H i g h e s t I n t e g r a t e d V o l u m e} H j}{{\sum }_{j = R V a t L o w e s t I n t e g r a t e d V o l u m e}^{j = R V a t H i g h e s t I n t e g r a t e d V o l u m e} H j}$$
$$C D {F}_{I R \geq 200 , 000 M W} = \frac{{\sum }_{j = R V a t L o w e s t I n t e g r a t e d V o l u m e}^{j = R V a t 200 , 000 M W} H j}{{\sum }_{j = R V a t L o w e s t I n t e g r a t e d V o l u m e}^{j = R V a t H i g h e s t I n t e g r a t e d V o l u m e} H j}$$
$$C D {F}_{D V \leq 25 , 000 M W} = \frac{{\sum }_{j = R V a t 25 , 000 M W}^{j = R V a t H i g h e s t I n t e g r a t e d V o l u m e} H j}{{\sum }_{j = R V a t L o w e s t I n t e g r a t e d V o l u m e}^{j = R V a t H i g h e s t I n t e g r a t e d V o l u m e} H j}$$
$$C D {F}_{D V \geq 1 , 000 , 000 M W} = \frac{{\sum }_{j = R V a t L o w e s t I n t e g r a t e d V o l u m e}^{j = R V a t 1 , 000 , 000 M W} H j}{{\sum }_{j = R V a t L o w e s t I n t e g r a t e d V o l u m e}^{j = R V a t H i g h e s t I n t e g r a t e d V o l u m e} H j}$$
$$C D {F}_{L S \leq 100 , 000 M W} = \frac{{\sum }_{j = R V a t 100 , 000 M W}^{j = R V a t H i g h e s t I n t e g r a t e d V o l u m e} H j}{{\sum }_{j = R V a t L o w e s t I n t e g r a t e d V o l u m e}^{j = R V a t H i g h e s t I n t e g r a t e d V o l u m e} H j}$$
$$C D {F}_{L S \geq 1 , 500 , 000 M W} = \frac{{\sum }_{j = R V a t L o w e s t I n t e g r a t e d V o l u m e}^{j = R V a t 1 , 500 , 000 M W} H j}{{\sum }_{j = R V a t L o w e s t I n t e g r a t e d V o l u m e}^{j = R V a t H i g h e s t I n t e g r a t e d V o l u m e} H j}$$

### gpcBR Branching Index by Triple Detector GPC (3D-GPC)

The gpcBR branching index is determined by first calibrating the light scattering, viscosity, and concentration detectors as described previously. Baselines are then subtracted from the light scattering, viscometer, and concentration chromatograms. Integration windows are then set to ensure integration of all of the low molecular weight retention volume range in the light scattering and viscometer chromatograms that indicate the presence of detectable polymer from the infrared (IR5) chromatogram. Linear polyethylene standards are then used to establish polyethylene and polystyrene Mark-Houwink constants. Upon obtaining the constants, the two values are used to construct two linear reference conventional calibrations for polyethylene molecular weight and polyethylene intrinsic viscosity as a function of elution volume, as shown in Equations (11) and (12):

$${\text{MW}}_{\text{PE}} = {\left({\text{K}}_{\text{PS}} / {\text{K}}_{\text{PE}}\right)}^{1 / {α}_{\text{PE}} + 1} ⋅ {\text{MW}}_{\text{PS}} {}^{{α}_{\text{PS}} + 1 / {α}_{\text{PE}} + 1}$$

$${\left[η\right]}_{\text{PE}} = {\text{K}}_{\text{PS}} = {\text{K}}_{\text{PS}} ⋅ {\text{MW}}_{\text{PS}} {}^{α + 1} / {\text{MW}}_{\text{PE}}$$

The gpcBR branching index is a robust method for the characterization of long chain branching as described in Yau, Wallace W., “Examples of Using 3D-GPC—TREF for Polyolefin Characterization,” Macromol. Symp., 2007, 257, 29-45. The index avoids the “slice-by-slice” 3D-GPC calculations traditionally used in the determination of g′ values and branching frequency calculations, in favor of whole polymer detector areas. From 3D-GPC data, one can obtain the sample bulk absolute weight average molecular weight (Mw(abs)) by the light scattering (LS) detector, using the peak area method. The method avoids the “slice-by-slice” ratio of light scattering detector signal over the concentration detector signal, as required in a traditional g′ determination.

With 3D-GPC, sample intrinsic viscosities are also obtained independently using Equation (13). This area calculation offers more precision, because, as an overall sample area, it is much less sensitive to variation caused by detector noise and 3D-GPC settings on baseline and integration limits. More importantly, the peak area calculation is not affected by the detector volume offsets. Similarly, the high-precision sample intrinsic viscosity (IV) is obtained by the area method shown in Equation (13):

$$I {V}_{w} = \frac{\sum {}_{i} {c}_{i} I {V}_{i}}{\sum {}_{i} {c}_{i}} = \frac{\sum {}_{i} {η}_{s p {}_{i}}}{\sum {}_{i} {c}_{i}} = \frac{V i s c o m e t e r A r e a}{C o n c . A r e a}$$

where ηₛₚᵢ stands for the specific viscosity as acquired from the viscometer detector.

To determine the gpcBR branching index, the light scattering elution area for the sample polymer is used to determine the molecular weight of the sample. The viscosity detector elution area for the sample polymer is used to determine the intrinsic viscosity (IV or [η]) of the sample.

Initially, the molecular weight and intrinsic viscosity for a linear polyethylene standard sample, such as SRM1475a or an equivalent, are determined using the conventional calibrations (“cc”) for both molecular weight and intrinsic viscosity as a function of elution volume, per Equations (14) and (15):

$${\left[η\right]}_{c c} = \frac{\sum {}_{i} {c}_{i} I {V}_{i , c c}}{\sum {}_{i} {c}_{i}} = {\frac{\sum {}_{i} {c}_{i} K \left({M}_{i , c c}\right)}{\sum {}_{i} {c}_{i}}}^{\text{a}}$$

Equation (15) is used to determine the gpcBR branching index:

$$g p c B R = \left[\left(\frac{\left[η\right] c c}{\left[η\right]}\right) {\left(\frac{{M}_{w}}{{M}_{w , c c}}\right)}^{{α}_{P E}} - 1\right]$$

wherein [η] is the measured intrinsic viscosity, [η]_{cc} is the intrinsic viscosity from the conventional calibration, Mw is the measured weight average molecular weight, and Mw,_{cc} is the weight average molecular weight of the conventional calibration. The weight average molecular weight by light scattering (LS) is commonly referred to as “absolute weight average molecular weight” or “Mw, Abs.” The Mw,cc from Equation (7) using conventional GPC molecular weight calibration curve (“conventional calibration”) is often referred to as “polymer chain backbone molecular weight,” “conventional weight average molecular weight,” and “Mw (conv).”

All statistical values with the “cc” subscript are determined using their respective elution volumes, the corresponding conventional calibration as previously described, and the concentration (Ci). The non-subscripted values are measured values based on the mass detector, LALLS, and viscometer areas. The value of K_{PE} is adjusted iteratively, until the linear reference sample has a gpcBR measured value of zero. For example, the final values for α and Log K for the determination of gpcBR in this particular case are 0.725 and -3.391, respectively, for polyethylene, and 0.722 and -3.993, respectively, for polystyrene. Once the K and α values have been determined using the procedure discussed previously, the procedure is repeated using the branched samples. The branched samples are analyzed using the final Mark-Houwink constants obtained from the linear reference as the best “cc” calibration values. For linear polymers, gpcBR calculated from Equation (15) will be close to zero, since the values measured by LS and viscometry will be close to the conventional calibration standard. For branched polymers, gpcBR will be higher than zero, especially with high levels of long chain branching, because the measured polymer molecular weight will be higher than the calculated Mw,cc, and the calculated IVcc will be higher than the measured polymer IV. In fact, the gpcBR value represents the fractional IV change due the molecular size contraction effect as the result of polymer branching. A gpcBR value of 0.5 or 2.0 would mean a molecular size contraction effect of IV at the level of 50% and 200%, respectively, versus a linear polymer molecule of equivalent weight. For these particular examples, the advantage of using gpcBR, in comparison to a traditional “g′ index” and branching frequency calculations, is due to the higher precision of gpcBR. All of the parameters used in the gpcBR index determination are obtained with good precision, and are not detrimentally affected by the low 3D-GPC detector response at high molecular weight from the concentration detector. Errors in detector volume alignment also do not affect the precision of the gpcBR index determination.

### LSP Parameter

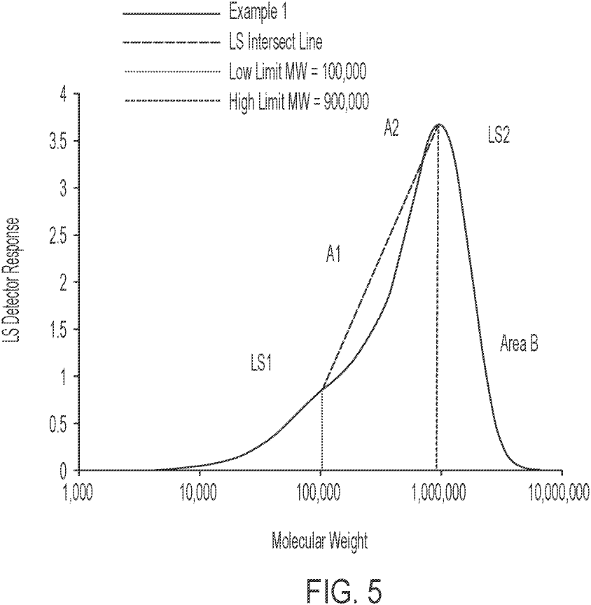

Representative values for the GPC Light Scattering Parameters (LSP) can be found in Tables 1 and 2 and FIG. 5 for Example 1. Analysis of materials were performed in a similar manner to U.S. Pat. No. 8,916,667B2 (Karjala et al.). The X-axis in the plot is the logarithmic value of the molecular weight by conventional GPC calculation, or cc-GPC molecular weight. The y-axis is the LS detector response. The specific features of the LS elution profile are captured as defined by two log-molecular weight limits. The lower limit corresponds to a MW1 value of 100,000 g/mol and the upper limit corresponds to a MW2 value of 900,00 g/mol. The vertical lines of these two molecular weight limits intersect with the LS elution curve at two points. A line segment is drawn connecting these two intercept points. The height of the LS signal at the first intercept (log MW1) gives the LS1 quantity. The height of the LS signal at the second intercept (log MW2) gives the LS2 quantity. The area under the LS elution curve within the two molecular weight limits gives the quantity Area B. Comparing the LS curve with the line segment connecting the two intercepts, there can be part of the segregated area that it is above the line segment (see A2 in FIG. 5, defined as a negative value) or below the line segment (like A1 in FIG. 5, defined as a positive value). The sum of A1 and A2 gives the quantity Area A, the total Area A. This total area A can be calculated as the difference between the Area B and the area below the line segment.

The steps of calculating the “LS” quantity are illustrated with Example 1 shown in Tables 2 and Table 3.

Step 1 “Calculate SlopeF in Table 1, using equations 16-17 below:

$$S l o p e \_ v a l u e = \left[\left(L S 2 - L S 1\right) / L S 2\right] / d L o g M W$$

$$S l o p e F = a s l o p e f u n c t i o n = a b s \left(s l o p e \_ v a l u e - 0.42\right) + 0.001$$

Step 2, calculate ‘AreaF’ and “LSF’ in Table 2, using equations 18-19 below:

$$A r e a F = a n a r e a f u n c t i o n = A b s \left(A b s \left(A / B\right) + 0.033\right) \left(- 0.005\right)$$

where, A/B = (Area A)/(Area B)

$$L S P = L o g \left(A r e a F ∗ S l o p e F\right) + 4$$

TABLE 2

The “SlopeF” Calculation

| | MW1=100,000 g/mol | | MW2 =1900,000 g/mol | | Log (MW2)-Log (MW1) | | Abs (slope-0.42)+0.001 |
|---|---|---|---|---|---|---|---|
| Sample | LS1 | Log MW1 | LS2 | Log MW2 | dLog MW | Slope Value | Slope F |
| Ex. 1 | 0.84 | 5.00 | 3.65 | 5.95 | 0.95 | 0.8072 | 0.3882 |

TABLE 3

The “AreaF” and “LSP” Calculation

| Sample | LS Curve Area B | Area A (A1+A2) | A/B | Abs (Abs (A/B)+0.033)-0.005= Area F | Log (AreaF* SlopeF) + 4 =LSP |
|---|---|---|---|---|---|
| Ex. 1 | 304.125 | 63.5520 | 0.20897 | 0.2370 | 2.96 |

### Hexane Extractables

Polymer pellets (from polymerization pelletization process, without further modification; approx. 2.2 grams per one “1-inch × 1-inch” square film) were pressed in a Carver Press at a thickness of 3.0-4.0 mils. The pellets were pressed at 190° C. for 3 minutes at 8,000 psi followed by cooling for 3 minutes followed by another pressing at 190° C. for 3 minutes at 40,000 psi followed by cooling (12 minutes total). Non-residue gloves (PIP* CleanTeam* CottonLisle Inspection Gloves, Part Number: 97-501) were worn to prevent contamination of the film with residual oils from the operator hands. Each film was trimmed to a “1-inch x 1-inch” square, and weighed (2.5 ± 0.05 g). The films were extracted for 2 hours, in a hexane vessel, containing about 1000 ml of hexane, at 49.5 ± 0.5° C., in a heated water bath. The hexane was an isomeric “hexanes” mixture (for example, Hexanes (Optima), Fisher Chemical, high purity mobile phase for HPLC and/or extraction solvent for GC applications). After two hours, the films were removed, rinsed in clean hexane, and dried in a vacuum oven (80 ± 5° C.) at full vacuum (ISOTEMP Vacuum Oven, Model 281A, at approx.. 30 inches Hg) for two hours. The films were then placed in a desiccator, and allowed to cool to room temperature for at least one hour. The films were then reweighed, and the amount of mass loss due to extraction in hexane was calculated. This method is based on 21 CRF 177.1520 (d)(3)(ii), with one deviation from FDA protocol by using hexanes instead of n-hexane; reported average of 3 measurements.

### Slip Additives

About 5 grams of sample was weighed (and recorded to the nearest 0.0001-g) into a 16-oz glass bottle. A Polytetrafluoroethylene (PTFE)-coated stirrer bar was added to the bottle along with 120 mL of 0.04% triethyl phosphite in o-xylene using a solvent dispenser. The bottle was loosely capped and placed on a heated stirrer for 30 minutes at 130° C. with stirring. After 30 minutes, the bottle was removed to cool the solution at room temperature with stirring for at least 2 hours. The polymer was further precipitated with the addition of 250 mL of methanol to the bottle using a solvent dispenser. The solution was stirred during this addition. The solution was stirred for an additional 2 hours. After 2 hours of stirring, the bottle was removed and the solids were allowed to settle. An aliquot of solution was removed with a glass pipette and transferred into a 2-mL glass autosampler vial. The vial was capped and placed on the gas chromatograph for analysis. The samples and standard solutions were analyzed using gas chromatography with a pulsed splitless injection and a flame ionization detector. Concentrations in extracts were determined using an external standard calibration procedure. The data for erucamide, oleamide, or stearamide in the resin are reported in parts per million (ppm; µg/g).

### Antioxidants (AO)

About 5 grams of sample was weighed (and recorded to the nearest 0.0001-g) into a 4-oz glass bottle. A PTFE-coated stirrer bar was added to the bottle along with 25 mL of 0.04% triethyl phosphite in o-xylene using a solvent dispenser. The bottle was loosely capped and placed on a heated stirrer for 30 minutes at 130° C. with stirring. After 30 minutes, the bottle was removed to cool the solution at room temperature with stirring for at least 2 hours. The polymer was further precipitated with the addition of 50 mL of methanol to the bottle using a solvent dispenser. The solution was stirred during this addition. The solution was stirred for an additional 2 hours. After 2 hours of stirring, the bottle was removed and the solids were allowed to settle. An aliquot of solution was removed with a glass pipette and filtered with a 0.2 µm PTFE (25 mm) syringe filter and a polypropylene syringe into a 2 mL glass autosampler vial. The vial was capped and placed on the liquid chromatograph for analysis. The samples and standard solutions were analyzed using a reversed phase liquid chromatographic method with a UV/Vis absorbance detector. Concentrations in extracts were determined using an external standard calibration procedure. The data for AOs in resin are reported in parts per million (ppm; µg/g). Further details can be found in Green, S.; Bai, S.; Cheatham, M.; Cong, R.; Yau, W., “Determination of Antioxidants in Polyolefins Using Total Dissolution Methodology Followed by RPLC”, Journal of Separation Science, 33 (22), 3455 - 3462 (2010).

### Antiblocks

ASTM D6247 was used to determine metal levels by X-Ray Fluorescence. Talc or silicon dioxide can be determined from elemental silicon (Si) or magnesium (Mg) by XRF. In a laboratory where many different types of materials are analyzed, both Si and Mg can be measured. The talc result may be reported as calculated from either Si or Mg as appropriate. For example, the level of talc may be calculated by measuring Mg and Si. It may also be calculated by measuring the % residual ash. If only Mg and Si are present (no other additives etc.) the three measurements (XRF and % residual ash) should agree.

$${\text{Talc}}_{\left(\text{Mg}\right)} \text{=} {\text{Talc}}_{\left(\text{Si}\right)} \text{=} {\text{Talc}}_{\left(\text{ash}\right)} .$$

Talc may be determined by using both Mg and Si. If the two values are different, then further analysis may be required to determine the level of talc. For example, SiO₂ would result in a higher value for talc when calculated using the XRF value for Si.

$$\text{Talc} {}_{\left(\text{Mg}\right)} \text{<} \text{Talc} {}_{\left(\text{Si}\right) \text{.}}$$

The difference could be used to calculate the amount of SiO₂. After determining the SiO₂ level, the correction for the value of talc may be calculated from the % residual ash measurement.

$$\text{Talc} {}_{\left(\text{Ash} \text{corrected}\right)} \text{=} \text{Talc} {}_{\left(\text{Ash}\right)} \text{-} \text{Talc} {}_{\left(\text{SiO2}\right) \text{.}}$$

Also, if only SiO₂ is present and no Mg, the elemental determination of talc from Mg may result in zero talc. Residual ash may be determined by ASTM D5630: Standard Test Method for Ash Content in Plastics.

### Mineral Oil

About 5 grams of sample was weighed (and recorded to the nearest 0.0001-g) into a 4-oz glass bottle followed by addition of 20 mL of methylene chloride. The bottle was sealed with a PTFE lined cap. The samples was extracted for 24 h at room temperature on a wrist shaker. An aliquot of the extract was removed with a glass pipette and transferred to a 2 mL glass autosampler vial. The vial was capped and placed on the gas chromatograph for analysis. The samples and standard solutions were analyzed using a gas chromatographic method with a flame ionization detector. The standard solution was prepared in methylene chloride using the same mineral oil reference material as found in the resin. The mineral oil peak in the chromatogram was integrated. The oligomers and additive peak areas in the same retention time window as the mineral oil are subtracted from the mineral oil peak area. Concentrations in extracts were determined using an external standard calibration procedure. The data for mineral oil in resin are reported in parts per million (ppm; µg/g).

### EXAMPLES

### Example 1 and Comparative Example 1: Preparation of Low-density Polyethylenes

Following the previous description of FIG. 1, a mixture containing t-butyl peroxy-2 ethylhexanoate (TBPO) and an iso-paraffinic hydrocarbon solvent with a boiling range greater than 179° C. was used as the initiator mixture for the first and second injection points. A mixture containing TBPO, t-butyl peroxyacetate (TBPA), and an iso-paraffinic hydrocarbon solvent was used as the initiator mixture for the third injection point. A mixture containing di-t-butyl peroxide (DTBP), TBPA, TPBO, and the iso-paraffinic hydrocarbon solvent was used for the fourth injection point. Table 4 shows the composition in wt.% of the peroxide initiator and solvent solution used for each of the injection points.

TABLE 4

| | | Example 1 | Comparative Example 1 |
|---|---|---|---|
| Injection Point | Material | wt. % | wt.% |
| #1 | TBPO | 20 | 20 |
| #1 | Solvent | 80 | 80 |
| #2 | TBPO | 20 | 20 |
| #2 | Solvent | 80 | 80 |
| #3 | TBPO | 10 | 10 |
| #3 | TBPA | 10 | 10 |
| #3 | Solvent | 80 | 80 |
| #4 | TBPO | 6.3 | 6.3 |
| #4 | TBPA | 3.5 | 3.5 |
| #4 | DTBP | 4.2 | 4.2 |
| #4 | Solvent | 86 | 86 |

Isobutane was used as the chain transfer agent. The isobutane was injected into the ethylene stream at the suction side of the booster/primary compressor. The composition of the CTA feed to the process may be adjusted accordingly to maintain a desirable melt index in the product.

The process conditions used to manufacture the additive-free example and comparative example are given in Table 5. The reaction temperatures for each autoclave zone and to the tube are controlled by adjusting peroxide flows to each of the reaction zones. The reactor pressure and the reactor control temperatures are used to ultimately control the molecular weight distribution of the product.

TABLE 5

| Process Variable | Example 1 | Comparative Example 1 |
|---|---|---|
| Reactor Pressure (Psig) | 24,501 | 25,490 |
| Top Feed Temperature (°C) | 41 | 63 |
| Bottom Feed Temperature (°C) | 40 | 40 |
| Zone 1 Temperature (°C) | 218 | 218 |
| Zone 2 Temperature (°C) | 235 | 235 |
| Zone 3 Temperature (°C) | 255 | 255 |
| Re-initiation Temperature (°C) | 233 | 229 |
| Tube Peak Temperature (°C) | 281 | 282 |
| Fresh Ethylene Flow (lb/hr) | 19,167 | 19,020 |
| Ethylene Throughput to Reactor (lb/hr) | 67,149 | 67,103 |
| Ethylene Conversion (%) | 23 | 23 |
| Isobutane Flow (lb/hr) | 75 | 105 |
| Ethylene Purge Flow (lb/hr) | 999 | 995 |
| Boiling Water Drum Temperature to Tube (°C) | 126 | 126 |
| Boiling Water Return Temperature from Tube (°C) | 139 | 140 |

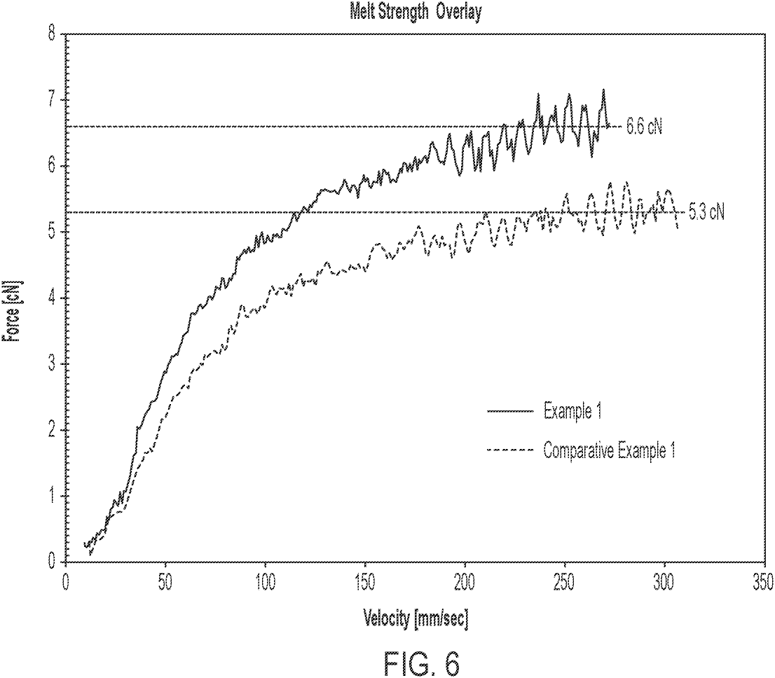

The examples and comparative examples were tested according to the testing procedures disclosed herein to measure the density, melt index (I₂), melt strength, and hexane extractables. The results of the density, melt index (I₂), melt strength, and hexane extractables of Example 1 and Comparative Example 1 are shown in Table 6 below. Referring to FIG. 6, the melt strength curves for Example 1 and Comparative Example 1, along with the melt strength plateau region as drawn by the horizontal line approximating the average melt strength at high velocity before the end of data (strand break), are graphically depicted.

TABLE 6

| Description | Density (g/cm³) | I₂ (g/10 min) | Melt Strength (cN) | Hexane Extractables (wt%) |
|---|---|---|---|---|
| Example 1 | 0.923 | 5.05 | 6.6 | 1.39 |
| Comparative Example 1 | 0.923 | 5.56 | 5.3 | 1.31 |

Molecular weight data for the various examples were measured according to the testing procedures disclosed herein and the results are shown in Table 7 below using both conventional (conv) and light scattering or absolute (abs) GPC methods.

TABLE 7

| Description | Mn (g/mol) (conv) | Mw (g/mol) (conv) | Mz (g/mol) (conv) | Mw/Mn (conv) | Mw (g/mol) (abs) | Mz (abs) | Mw(abs)/ Mw(conv) | gpcBR |
|---|---|---|---|---|---|---|---|---|
| Example 1 | 14,700 | 125,000 | 580,200 | 8.53 | 279,200 | 2,674,900 | 2.23 | 2.64 |
| Comparative Example 1 | 15,000 | 108,100 | 479,500 | 7.22 | 223,400 | 2,247,800 | 2.07 | 2.23 |

CDF and LSP data for the various examples were measured according to the testing procedures disclosed herein and the results are shown in Table 8 below.

TABLE 8

| Description | CDF IR ≤ 5,000 g/mol | CDF IR ≥ 200,000 g/mol | CDF DV ≤ 25,000 g/mol | CDF DV ≥ 1,000,000 g/mol | CDF LS ≤ 100,000 g/mol | CDF LS ≥ 1,500,000 g/mol | LSP |
|---|---|---|---|---|---|---|---|
| Example 1 | 0.0746 | 0.1559 | 0.1194 | 0.0608 | 0.1034 | 0.1428 | 2.96 |
| Comparative Example 1 | 0.0743 | 0.1348 | 0.1275 | 0.417 | 0.1352 | 0.1107 | 2.46 |

Viscosity data for the various examples were measured according to the testing procedures disclosed herein and the results are shown in Table 9 below.

TABLE 9

| Description | Viscosity @0.1 radians/ second and 190° C. (Pa•s) | Viscosity @ 1.0 radians/ second and 190° C. (Pa•s) | Viscosity @ 10 radians/ second and 190° C. (Pa•s) | Viscosity @ 100 radians/ second and 190° C. (Pa•s) | Viscosity Ratio (V@0.1/V(@100) and 190° C. | Tan delta @ 0.1 and 190° C. |
|---|---|---|---|---|---|---|
| Example 1 | 3,250 | 2,094 | 930 | 318 | 10.2 | 5.2 |
| Comparative Example 1 | 2,855 | 1,937 | 891 | 310 | 9.2 | 6.1 |

Branching data in branches per 1000 C by ¹³C NMR for the various examples were measured according to the testing procedures disclosed herein and the results are shown in Table 10 below.

TABLE 10

| Description | C₁ Branches (per 1000 Total Carbons) | 1,3 diethyl Branches (per 1000 Total Carbons) | C₂ on Quaternary Carbon (per 1000 Total Carbons) | C₄ (per 1000 Total Carbons) | C₅ (per 1000 Total Carbons) | C₆₊ (per 1000 Total Carbons) |
|---|---|---|---|---|---|---|
| Example 1 | Not Detected | 3.5 | 1.2 | 7.2 | 2.3 | 3.4 |
| Comparative Example 1 | Not Detected | 3.7 | 1.2 | 6.9 | 2.2 | 3.4 |

Unsaturation data by ¹H NMR for the various comparative examples and examples was measured according to the testing procedures disclosed herein and the results are shown in Table 11 below.

TABLE 11

| Description | Vinyl (per 1000 Total Carbons) | Cis and Trans Vinylenes (per 1000 Total Carbons) | Trisubstituted (per 1000 Total Carbons) | Vinylidene (per 1000 Total Carbons) | Total Unsaturation (per 1000 Total Carbons) |
|---|---|---|---|---|---|
| Example 1 | 0.033 | 0.022 | 0.056 | 0.163 | 0.274 |
| Comparative Example 1 | 0.023 | 0.020 | 0.048 | 0.147 | 0.238 |

1. A low-density polyethylene homopolymer comprising:
a melt strength measured at 190° C. that is greater than or equal to 5.5 cN;
a density that is greater than or equal to 0.9210 g/cm³ and less than or equal to 0.9275 g/cm³; and
a melt index I₂ measured at 190° C. that is greater than or equal to 4.5 g/10 min.

2. The low-density polyethylene homopolymer of claim 1, wherein the melt index I₂ measured at 190° C. is greater than or equal to 4.5 g/10 min and less than or equal to 7.5 g/10 min.

3. The low-density polyethylene homopolymer of claim 1 wherein the melt index I₂ measured at 190° C. is greater than or equal to 4.5 g/10 min and less than or equal to 6.5 g/10 min.

4. The low-density polyethylene homopolymer of claim 1, wherein the melt strength measured at 190° C. is greater than or equal to 6.0 cN and less than or equal to 8.5 cN.

5. The low-density polyethylene homopolymer of claim 1, wherein the melt strength measured at 190° C. is greater than or equal to 6.4 cN and less than or equal to 7.0 cN.

6. The low-density polyethylene homopolymer of claim 1, wherein the melt strength measured at 190° C. in cN is greater than or equal to -0.780*(melt index, I₂)+9.9 cN ± 5%.

7. The low-density polyethylene homopolymer of claim 1, wherein the low-density polyethylene comprises a molecular weight distribution (Mw(conv)/Mn(conv)) that is greater than or equal to 7.2.

8. The low-density polyethylene homopolymer of claim 1, wherein the density is greater than or equal to 0.9220 g/cm³ and less than or equal to 0.9265 g/cm³.

9. The low-density polyethylene homopolymer of claim 1, wherein a hexane extractables level is less than or equal to 2.60%.

10. The low-density polyethylene homopolymer of claim 1, wherein the low-density polyethylene comprises a z-average molecular weight Mz (conv) that is greater than 500,000 g/mol.

11. The low-density polyethylene homopolymer of claim 1, wherein the low-density polyethylene comprises a z-average molecular weight Mz (conv) that is greater than or equal to 530,000 g/mol and less than or equal 620,000 g/mol.

12. The low-density polyethylene homopolymer of claim 1, wherein the low-density polyethylene comprises a GPC-light scattering parameter (LSP) that is greater than 2.5.

13. A film comprising the low-density polyethylene homopolymer of claim 1.

14. A film comprising a mixture of linear low-density polyethylene (LLDPE) and the low-density polyethylene homopolymer of claim 1.

15. A cast, blown, or thermoformed film comprising the low-density polyethylene homopolymer of claim 1.
